(19) United States
(12) Patent Application Publication
(10) Pub. No.: US 2024/0169251 A1
(43) Pub. Date: May 23, 2024

(54) PREDICTING COMPLIANCE OF TEXT DOCUMENTS WITH A RULESET USING SELF-SUPERVISED MACHINE LEARNING

(71) Applicant: FMR LLC, Boston, MA (US)

(72) Inventors: Vallex Herard, Upper Nyack, NY (US); Arindam Paul, Bangalore (IN); Sarath R. Nair, Alappuzha (IN); Jason Matthew Megaro, Northborough, MA (US); John Mariano, Plymouth, MA (US); Pradeep Mooda, Hyderabad (IN)

(21) Appl. No.: 17/990,043

(22) Filed: Nov. 18, 2022

(51) Int. Cl. G06N 20/00

(52) U.S. Cl. CPC G06N 20/00

(57) ABSTRACT

Methods and apparatuses are described for predicting compliance of text documents with a ruleset using self-supervised machine learning. A server executes an NLP teacher model on first unlabeled sentences to generate a first compliance pseudo-label for each first unlabeled sentence. The server trains an NLP student model using the first unlabeled sentences and first compliance pseudo-labels, including injecting input noise by aggregating each unlabeled sentence with one or more sentences adjacent to each unlabeled sentence into a sentence block and providing the aggregated sentence blocks as input to train the NLP student model. The server executes the trained NLP student model, using second unlabeled sentences, to generate a second compliance pseudo-label for each second unlabeled sentence. The server determines compliance of the second sentences with one or more rulesets using the second compliance pseudo-labels.

### TECHNICAL FIELD

This application relates generally to methods and apparatuses, including computer program products, for predicting compliance of text documents with a ruleset using self-supervised machine learning.

### BACKGROUND

Many organizations, particularly in industries that are highly regulated by government, have to constantly ensure compliance of communications and documents with specific rulesets and regulations imposed by such governmental entities (e.g., SEC, FINRA). Particularly for large entities, this task can be overwhelming due to the sheer volume of communications and documents that are issued to customers, brokers, vendors, and others on a daily basis. In addition, these documents may comprise multiple different digital formats and structures which makes automated review less desirable.

More recently, some organizations have attempted to use advanced machine learning text classification models and algorithms to determine whether certain documents or corpora of text are compliant with particular rulesets. However, because these documents are often domain-specific or organization-specific, the training data sets available for organizations to train their machine learning models are usually quite small and potentially sparse—which leads to inefficient model training processes and the development of weak or inaccurate classification models. Furthermore, the use of small datasets for training models can result in overfitting and poor performance of the trained classification model.

Also, when a trained classification model has achieved a high accuracy, it generally requires much more training data to arrive at even a marginal improvement to the model. However, large amounts of quality training data may not be readily available.

### SUMMARY

Therefore, what is needed are methods and systems that improve upon existing machine learning classification model training by applying semi-supervised machine learning techniques to leverage large amounts of unlabeled text document data for the purpose of iteratively training a machine learning classification model using a teacher-student paradigm. The techniques described herein advantageously provide for a pathway to increase the accuracy, precision, and recall of domain-specific text classification models without requiring the collection or generation of large amounts of newly-created training data. In addition, by training the machine learning classification model on noisy data, generalizability of the model also improves on the overall data distribution.

The invention, in one aspect, features a computer system for predicting compliance of text documents with a ruleset using self-supervised machine learning. The system comprises a server computing device having a memory for storing computer-executable instructions and a processor that executes the computer-executable instructions. The server computing device executes a natural language processing (NLP) teacher model, using as input a first plurality of unlabeled sentences from each of a first plurality of text documents, to generate a first compliance pseudo-label for each unlabeled sentence in the first plurality of unlabeled sentences. The server computing device trains an NLP student model using the first plurality of unlabeled sentences and associated first compliance pseudo-labels, including injecting input noise during the training process by aggregating each unlabeled sentence with one or more sentences adjacent to each unlabeled sentence into a sentence block and providing the aggregated sentence blocks as input to train the NLP student model. The server computing device executes the trained NLP student model, using as input a second plurality of unlabeled sentences from each of a second plurality of text documents, to generate a second compliance pseudo-label for each unlabeled sentence in the second plurality of unlabeled sentences. The server computing device determines whether each text document in the second plurality of text documents is in compliance with one or more rulesets using the second compliance pseudo-labels generated for the text document.

The invention, in another aspect, features a computerized method of predicting compliance of text documents with a ruleset using self-supervised machine learning. A server computing device executes a natural language processing (NLP) teacher model, using as input a first plurality of unlabeled sentences from each of a first plurality of text documents, to generate a first compliance pseudo-label for each unlabeled sentence in the first plurality of unlabeled sentences. The server computing device trains an NLP student model using the first plurality of unlabeled sentences and associated first compliance pseudo-labels, including injecting input noise during the training process by aggregating each unlabeled sentence with one or more sentences adjacent to each unlabeled sentence into a sentence block and providing the aggregated sentence blocks as input to train the NLP student model. The server computing device executes the trained NLP student model, using as input a second plurality of unlabeled sentences from each of a second plurality of text documents, to generate a second compliance pseudo-label for each unlabeled sentence in the second plurality of unlabeled sentences. The server computing device determines whether each text document in the second plurality of text documents is in compliance with one or more rulesets using the second compliance pseudo-labels generated for the text document.

Any of the above aspects can include one or more of the following features. In some embodiments, the NLP teacher model and the NLP student model each comprises a deep learning NLP model architecture. In some embodiments, the NLP teacher model is trained using a corpus of text documents where each sentence is associated with a compliance label. In some embodiments, the compliance label is an indicator of whether the corresponding sentence is in compliance with one or more rulesets.

In some embodiments, the first compliance pseudo-label is a prediction of whether the corresponding sentence is in compliance with one or more rulesets. In some embodiments, the second compliance pseudo-label is a prediction of whether the corresponding sentence is in compliance with one or more rulesets. In some embodiments, determining whether each text document in the second plurality of text documents is in compliance with one or more rulesets comprises determining that the text document in the second plurality of text documents is not in compliance with the one or more rulesets when at least one sentence in the text document is labeled as being non-compliant.

In some embodiments, the server computing device trains a second NLP student model using the second plurality of unlabeled sentences and associated second compliance pseudo-labels, including injecting input noise during the training process by aggregating each unlabeled sentence with one or more sentences adjacent to each unlabeled sentence into a sentence block and providing the aggregated sentence blocks as input to train the second NLP student model. The server computing device executes the trained second NLP student model, using as input a third plurality of unlabeled sentences from each of a third plurality of text documents, to generate a third compliance pseudo-label for each unlabeled sentence in the third plurality of unlabeled sentences. The server computing device determines whether each text document in the third plurality of text documents is in compliance with one or more rulesets using the third compliance pseudo-labels generated for the text document. In some embodiments, the second plurality of text documents comprises a larger number of sentences than the first plurality of text documents.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for predicting compliance of text documents with a ruleset using self-supervised machine learning.

FIG. 2 is a flow diagram of a computerized method of predicting compliance of text documents with a ruleset using self-supervised machine learning.

FIG. 3 is a flow diagram of an exemplary use case for predicting compliance of text documents with a ruleset using self-supervised machine learning.

### DETAILED DESCRIPTION

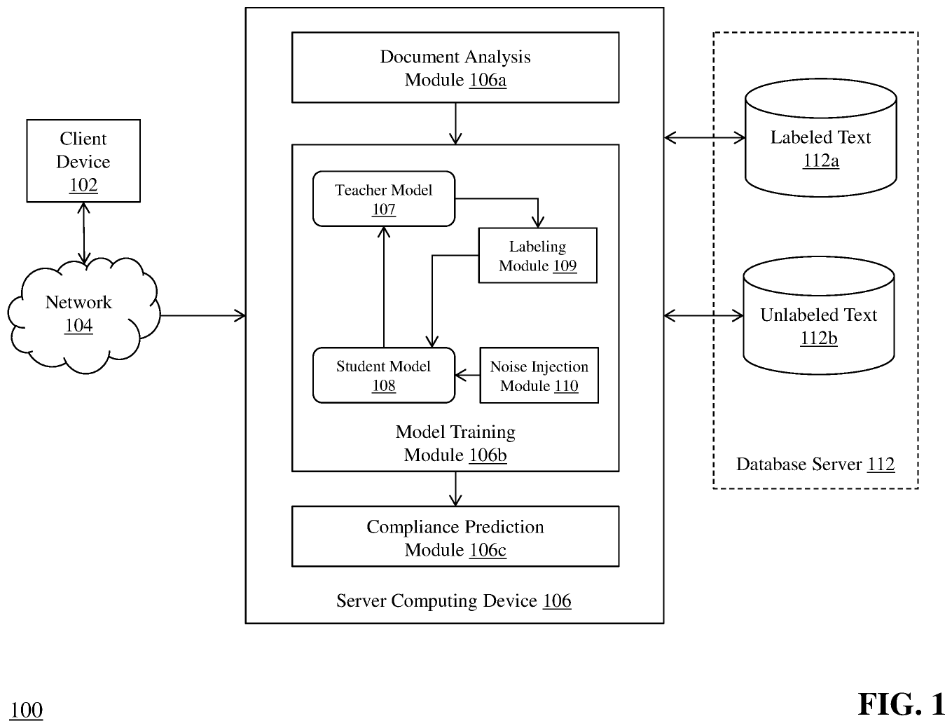

FIG. 1 is a block diagram of a system 100 for predicting compliance of text documents with a ruleset using self-supervised machine learning. System 100 includes client computing device 102, communication network 104, server computing device 106 that includes document analysis module 106a, model training module 106b that includes teacher model 107, student model 108, labeling module 109, and noise injection module 110, and compliance prediction module 106c, and database server 112 comprising labeled text database 112a and unlabeled text database 112b.

Client computing device 102 connects to communication network 104 in order to communicate with server computing device 106 to provide input and receive output relating to the process of predicting compliance of text documents with a ruleset using self-supervised machine learning as described herein. In some embodiments, client computing device 102 is coupled to an associated display device (not shown). For example, client computing device 102 can provide a graphical user interface (GUI) via the display device that is configured to receive input from a user of the device 102 and to present output (e.g., documents, reports, digital content items) to the user that results from the methods and systems described herein.

Exemplary client computing devices 102 include but are not limited to desktop computers, laptop computers, tablets, mobile devices, smartphones, and internet appliances. It should be appreciated that other types of computing devices that are capable of connecting to the components of system 100 can be used without departing from the scope of invention. Although FIG. 1 depicts a single client computing device 102, it should be appreciated that system 100 can include any number of client computing devices.

Communication network 104 enables the client computing device 102 to communicate with server computing device 106. Network 104 is typically a wide area network, such as the Internet and/or a cellular network. In some embodiments, network 104 is comprised of several discrete networks and/or sub-networks (e.g., cellular to Internet).

Server computing device 106 is a device including specialized hardware and/or software modules that execute on a processor and interact with memory modules of server computing device 106, to receive data from other components of system 100, transmit data to other components of system 100, and perform functions for predicting compliance of text documents with a ruleset using self-supervised machine learning as described herein. As mentioned above, server computing device 106 includes document analysis module 106a, model training module 106b that includes teacher model 107, student model 108, labeling module 109, and noise injection module 110, which execute on one or more processors of server computing device 106. In some embodiments, models 107, 108 and modules 106a-106c, 109, 110 are specialized sets of computer software instructions programmed onto one or more dedicated processors in the server computing device 106 and can include specifically-designated memory locations and/or registers for executing the specialized computer software instructions.

Although the modules 106a-106c, 109, 110 and models 107, 108 are shown in FIG. 1 as executing within the same server computing device 106, in some embodiments the functionality of the modules 106a-106c, 109, 110 and models 107, 108 can be distributed among a plurality of server computing devices. As shown in FIG. 1, server computing device 106 enables the modules 106a-106c, 109, 110 and models 107, 108 to communicate with each other in order to exchange data for the purpose of performing the described functions. It should be appreciated that any number of computing devices, arranged in a variety of architectures, resources, and configurations (e.g., cluster computing, virtual computing, cloud computing) can be used without departing from the scope of the invention. The exemplary functionality of the modules 106a-106c, 109, 110 and models 107, 108 is described in detail below.

Database server 112 is a computing device (or set of computing devices) coupled to server computing device 106 and the databases are configured to receive, generate, and store specific segments of data relating to the process of predicting compliance of text documents with a ruleset using self-supervised machine learning as described herein. Database server 112 comprises a plurality of databases, including labeled text database 112a and unlabeled text database 112b. In some embodiments, all or a portion of the databases 112a-112b can be integrated with server computing device 106 or be located on a separate computing device or devices. Databases 112a-112b can comprise one or more databases configured to store portions of data used by the other components of the system 100, as will be described in greater detail below.

In some embodiments, labeled text database 112a and unlabeled text database 112b each comprises a plurality of digital documents, files, chat logs, and/or other types of structured or unstructured text corpora (or, in some embodiments, pointers to such data as stored on one or more remote computing devices). Typically, the plurality of digital documents and unstructured text corpora relate to a particular domain (e.g., financial services, investment) for which compliance with one or more rulesets (e.g., governmental regulations) is required. As can be appreciated, labeled text database 112a comprises text that has been previously labeled with compliance labels which indicate whether the text or a portion thereof is in compliance with one or more rulesets. In some embodiments, each sentence of a given digital document is assigned a separate compliance label. An example compliance label can be a binary value (e.g., 0 for non-compliant, 1 for compliant), an alphanumeric value (e.g., indicating the compliance result and one or more applicable rulesets), or other types of labeling mechanisms. The text in labeled text database 112a can comprise documents that have been manually reviewed for compliance and labeled and/or documents that have been previously analyzed and labeled by system 100. Unlabeled text database 112b comprises text that has not been labeled for compliance—as explained herein, this text is analyzed by an NLP teacher model to determine compliance pseudo-labels, which are then used for training an NLP student model.

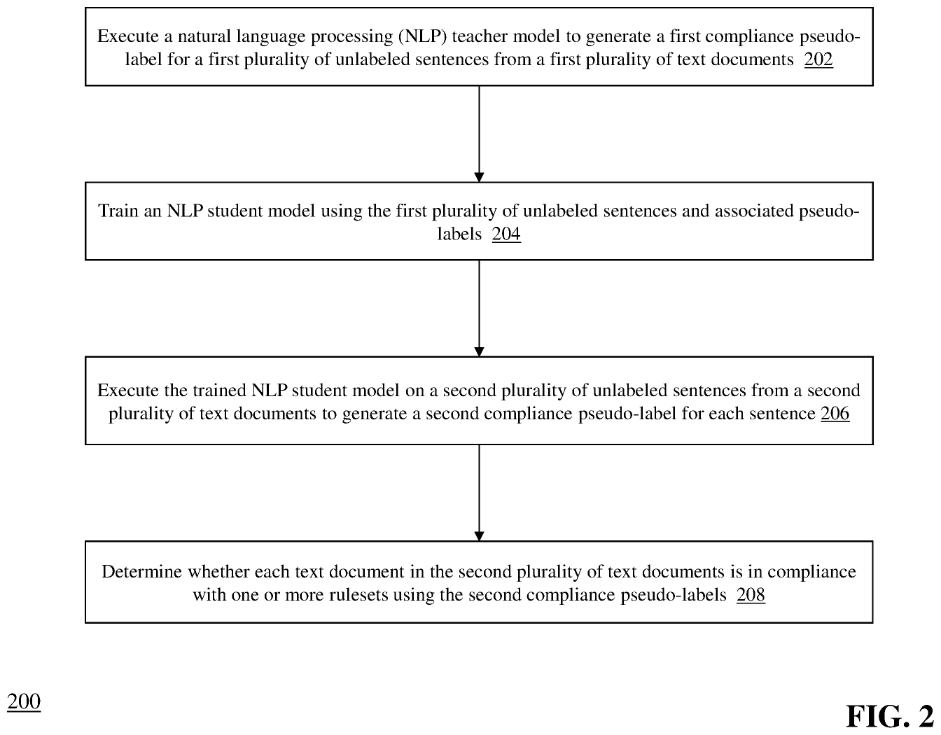

FIG. 2 is a flow diagram of a computerized method 200 of predicting compliance of text documents with a ruleset using self-supervised machine learning, using system 100 of FIG. 1. Method 200 can be understood as comprising two phases: a model training phase and a model execution phase. During the model training phase, model training module 106b executes a trained NLP teacher model 107 on unlabeled text from database 112b to predict compliance pseudo-labels for each sentence in the unlabeled text, prepares an input data set comprising the unlabeled sentences and pseudo-labels using labeling module 109, uses the sentences and pseudo-labels as input to train an NLP student model 108 (including the injection of noise from noise injection module 110), and then uses the newly-trained NLP student model 108 as the new NLP teacher model 107 for a subsequent corpus of unlabeled sentences. In this context, the term ‘pseudo-label’ refers to a predicted compliance label generated by NLP teacher model 107 for a sentence of unlabeled text. It should be appreciated that in some embodiments, the model training phase includes the initial training of NLP teacher model 107 using text documents from labeled text database 112a that were previously labeled for compliance. In some embodiments, the model training phase can consist of a plurality of training and pseudo-labeling cycles. In each cycle, the NLP teacher model 107 is used to generate compliance pseudo-labels for unlabeled text documents, the labeled sentences and corresponding pseudo-labels are used to train NLP student model 108—which is typically equal in size to, or larger in size than, the current cycle's NLP teacher model 107—and the trained NLP student model 108 becomes the new NLP teacher model 107 for the next training cycle. Similar techniques have been used for the classification and labeling of images, as described in Q. Xie et al., “Self-training with Noisy Student improves ImageNet classification,” arXiv:1911.04252v4 [cs.LG] 19 Jun. 2020, available at arxiv.org/pdf/1911.04252.pdf, which is incorporated herein by reference.

During the model execution phase, the most recent trained NLP student model 108 from the training phase is executed by compliance prediction module 106c using another set of unlabeled text documents as input to generate predicted labels for the sentences in the documents and determine whether the documents are in compliance with one or more rulesets. Action can then be taken based upon the outcome of the compliance determination. Further details about the model training phase and model execution phase are provided below.

Model Training Phase

During the model training phase, model training module 106b executes (step 202) NLP teacher model 107 to generate a first compliance pseudo-label for a first plurality of unlabeled sentences from a first plurality of text documents. In some embodiments, NLP teacher model 107 comprises an ALBERT (A Lite BERT) machine learning architecture which uses a transformer encoder with GELU nonlinearities, as described in Z. Lan et al., “ALBERT: A LITE BERT for Self-Supervised Learning of Language Representations,” arXiv:1909.11942v6 [cs.CL] 9 Feb. 2020, available at arxiv.org/pdf/1909.11942.pdf, which is incorporated by reference. As can be appreciated, there are three main contributions that ALBERT makes over the design choices of BERT: 1) factorized embedding parameterization; 2) cross-layer parameter sharing; and 3) inter-sentence coherence loss—Sentence Order Prediction (SOP). As can be appreciated, in some embodiments module 106b executes on one or more processors of server computing device 106.

As mentioned above, NLP teacher model 107 can be pre-trained on an existing training data set comprising a corpus of text documents, each including a plurality of sentences that have already been labeled for compliance (such as by a human analyst). Model training module 106b can retrieve the labeled sentences and corresponding labels from labeled text database 112a for ingestion by NLP teacher model 107. The purpose of pre-training the initial NLP teacher model 107 is to provide a baseline machine learning model that can generate predicted pseudo-labels for sentences in text documents that are not yet labeled—which can then be used to train NLP student model 108. The pre-training process can fine tune an ‘off-the-shelf’ ALBERT model for, e.g., a specific subject matter and/or domain of the text to be labeled.

Once an initial NLP teacher model 107 is trained, document analysis module 106a retrieves the first plurality of unlabeled sentences from, e.g., text corpora, files, and other types of digital documents stored and/or referenced in unlabeled text database 112b. In some embodiments, document analysis module 106a performs one or more preprocessing steps on the incoming unlabeled sentences to prepare the sentences for ingestion and processing by NLP teacher model 107. Exemplary preprocessing steps include, but are not limited to: identifying and filtering out stopwords, unintelligible words, and/or domain-specific words, removing punctuation, identifying individual sentences in the corpus of text, and the like. In some embodiments, module 106a can also remove sentences that are shorter than a predetermined length and/or number of words. In some embodiments, module 106a uses a segmentation process (such as spaCy Sentence Segmenter (spacy.io/universe/project/spacy-sentence-segmentizer)) to identify each sentence in the text corpus.

In some embodiments, document analysis module 106a converts the sentences into a plurality of tokens using, e.g., a tokenization process. As can be understood, tokenization generally refers to the process of breaking down each sentence into a plurality of tokens, where each token corresponds to a particular word or phrase in the sentence. In some cases, a tokenized sentence may also include metadata tokens, such as start of sentence and end of sentence tokens. The tokenization process may also normalize the words/tokens from each sentence (e.g., converting uppercase to lowercase, remove or keep accent marks, remove spaces, and the like) so that NLP teacher model 107 receives a uniform and consistent lexicon of words when performing the pseudo-labeling process.

After tokenization, model training module 106b executes (step 202) NLP teacher model 107 NLP teacher model 107 to generate a first compliance pseudo-label for a first plurality of unlabeled sentences from a first plurality of text documents. As described above, a pseudo-label can comprise a numeric value or values, and/or alphanumeric value or values, that indicates whether a given sentence is compliant or not with one or more rulesets. In some embodiments, NLP teacher model 107 predicts the pseudo-label for a given sentence based upon the model structure as generated from the training data set. For example, model 107 converts an input sentence into an embedding (i.e., a matrix of one or more dimensions/numeric values) based upon certain characteristics of the sentence and/or tokens in the sentence (e.g., word choice, semantic relationship between words or phrases, syntax, structure, etc.). NLP teacher model 107 processes the input embedding through one or more transformers each having a plurality of weighted or unweighted layers (such as self-attention layers, feed forward layers, etc.), created through analysis of the training data set, to generate a transposed embedding that is processed by a softmax function to generate a probability (or prediction) that the sentence is compliant (or is not compliant) with one or more rulesets. In some embodiments, the prediction comprises an output value corresponding to the compliance determination. Labeling module 109 receives the output values and the corresponding unlabeled sentences and can generate and apply a given compliance pseudo-label (e.g., 0, 1, ‘compliant,’ ‘non-compliant,’ etc.) to each sentence based upon the output value(s).

Model training module 106b trains (step 204) NLP student model 108 using the first plurality of unlabeled sentences (and/or embedding representations of the unlabeled sentences) and the corresponding compliance pseudo-labels generated by labeling module 109. Advantageously, in some embodiments, NLP student model 108 comprises an ALBERT model that is equal in size to, or larger in size than, the current NLP teacher model 107. For example, NLP teacher model 107 for a given cycle may comprise an albert-base-v1 model (i.e., 12 repeating layers, 128 embedding dimension, 768 hidden dimension, 12 attention heads, 11M parameters), whereas NLP student model 108 for the same cycle may comprise an albert-large-v2 model (i.e., 24 repeating layers, 128 embedding dimension, 1024 hidden dimension, 16 attention heads, 17M parameters).

Additionally, the training process for NLP student model 108 can include the injection of noise into NLP student model 108 and/or the training data set (via noise injection module 110) in order to provide several benefits to the student model training process, including reducing training time, improving test error, regularization to reduce overfitting, increasing robustness of student model, and the like. In some embodiments, noise injection module 110 performs one or more noise injection processes during training of NLP student model 108 such as: data augmentation, dropout, and stochastic depth. Data augmentation generally relates to constructing synthetic data from the training data set, where the synthetic data comprises small changes to the data and/or combinations of training examples that the model would not infer otherwise. One example of data augmentation can be using sentences in the training data set to select neighboring text from a pre-defined window size randomly and using the selected text portion(s) as the ‘unlabeled sentence’ for training purposes. Dropout generally relates to dropping a unit and associated connections in the neural network at training time (randomly or with a specified probability value) so that the model is trained using different, thinned versions of the neural network—which prevents co-adapting and overfitting. Further information about dropout techniques used by noise injection module 110 is described in N. Srivastava et al., “Dropout: A Simple Way to Prevent Neural Networks from Overfitting,” Journal of Machine Learning Research (JMLR) 15 (2014), 1929-1958, Jun. 14, 2014, which is incorporated herein by reference. Stochastic depth generally relates to utilization of shallow networks during training by starting with a deep network and randomly dropping a subset of layers and bypass them with the identity function—which reduces training time and improves test error. Further information about stochastic depth used by noise injection module 110 is described in G. Huang et al., “Deep Networks with Stochastic Depth,” arXiv:1603.09382v3 [cs.LG] 28 Jul. 2016, available at arxiv.org/1603.09382.pdf, which is incorporated herein by reference. Another example of noise injection can be adding noise to NLP student model 108 itself through adjusting weights, activations, gradients, and so forth. Training NLP student model 108 with noise improves the robustness of the model and accuracy of the model predictions.

As mentioned above, once NLP student model 108 is trained on the first plurality of unlabeled sentences and corresponding pseudo-labels, the newly-trained NLP student model 108 becomes the NLP teacher model 107 and in some embodiments, the model training phase repeats for one or more additional cycles. For example, in each cycle, document analysis module 106a retrieves a further plurality of unlabeled sentences from unlabeled text database 112 and uses the newly-trained NLP student model as the teacher model for prediction of pseudo-labels for the further plurality of sentences. Then, model training module 106 trains a further new NLP student model (that is equal in size to, or larger in size than) the current NLP teacher model— while also injecting noise into the new training data set—to generate another new NLP student model.

Upon completion of a certain number of cycles, model training module 106 can determine that the currently-trained NLP student model 108 can be used to predict labels for a new, unlabeled corpus of text documents in order to determine whether these documents are compliant or not compliant. At this point, the model training phase ends and system 100 moves to the model execution phase.

Model Execution Phase

As mentioned previously, during the model execution phase, compliance prediction module 106c executes (step 206) the recent trained NLP student model 108 on a second plurality of unlabeled sentences from a second plurality of text documents as input to generate a second compliance pseudo-label for each sentence. In some embodiments, the second plurality of text documents may comprise a set of newly-created, previously unlabeled documents that an organization wants to validate as compliant (or not) prior to releasing them to customers or otherwise using them in business activities. Compliance prediction module 106c can receive the second plurality of documents from, e.g., unlabeled text database 112b and in some embodiments, perform one or more preprocessing steps on the documents (using document analysis module 106a as described above) in order to prepare the documents for ingestion by trained NLP student model 108.

Then, the unlabeled sentences (and/or embedding representations) are provided to trained NLP student model 108 as input for execution of the model to generate a compliance pseudo-label for each sentence. In this context, the compliance pseudo-label may be considered as a ‘label’ for the sentence, as the training process described above improved the efficiency, reliability, precision, and recall of NLP student model 108 to a point that is suitable for live production compliance analysis.

Once the sentences in the second plurality of text documents are labeled by NLP student model 108, compliance prediction module 106c determines (step 208) whether each text document in the second plurality of text documents is in compliance with one or more rulesets using the second compliance pseudo-labels. As can be appreciated, there are several different ways that may be contemplated for determining compliance of a document based upon the sentence labels. For example, module 106c can determine that a particular text document is not in compliance if at least one of the sentences is labeled as non-compliant. In another example, module 106c can determine that a particular text document is not in compliance when a document contains a specific percentage or threshold value of sentences that are not in compliance (e.g., 5%, 10%, 25%, etc.). Upon making the determination that a document is non-compliant, module 106c can issue a notification to a remote computing device regarding the non-compliance and request remediation of the issues. For example, module 106c can transmit an electronic communication to a remote computing device operated by an analyst, where the electronic communication includes (i) the text document at issue and (ii) a message indicating to the analyst that the document is not in compliance with one or more rulesets (including identification of the particular ruleset(s)). In some embodiments, module 106c can highlight the individual sentences in the text document that are labeled as not compliant by NLP student model 108—enabling the analyst to quickly locate the issues and remediate them if necessary.

In another example, compliance prediction module 106c can identify one or more attributes of the text document that is not in compliance and take steps to automatically deprecate or remove the document from customer/public access. For example, module 106c can scan the digital document attributes (e.g., filename, creation date, storage location, author, and other document metadata) to determine a fingerprint for the text document that can be matched to, e.g., a file repository, web link, or other document storage to identify copies of the offending document and deactivate access to the document (by, e.g., restricting access permissions, deleting the copies, issuing recall notices, and so forth). This automated mechanism ensures that non-compliant documents are detected and removed from circulation or distribution as quickly as possible, to avoid any regulatory compliance violations or issues.

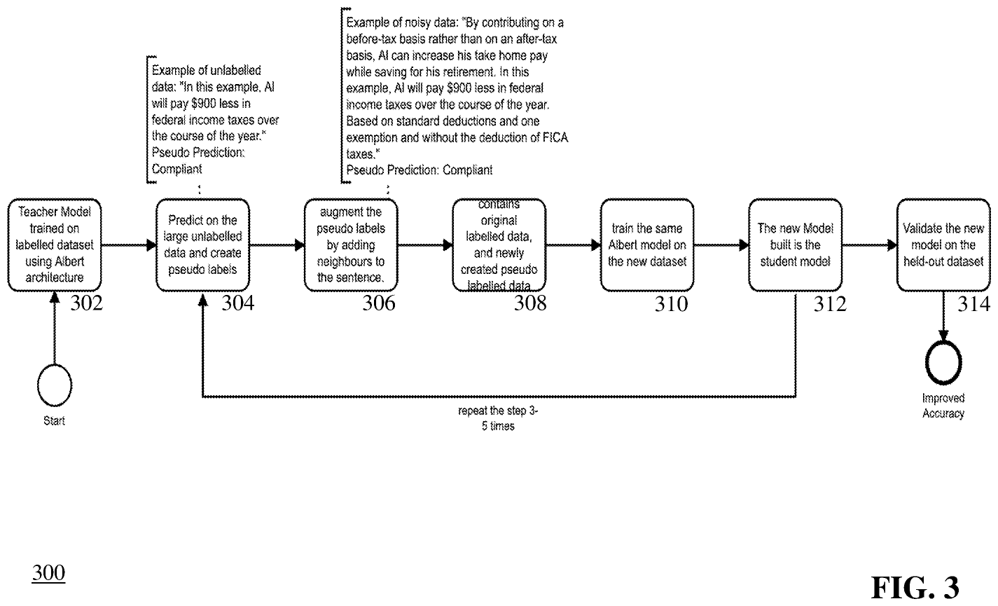

FIG. 3 is a flow diagram of an exemplary use case 300 for predicting compliance of text documents with a ruleset using self-supervised machine learning, using system 100 of FIG. 1. In the use case shown in FIG. 3, model training module 106b trains (step 302) teacher model 107 using a labeled text dataset retrieved from database 112a. In this example, teacher model 107 comprises an ALBERT-based architecture. Model training module 106b then executes (step 304) the trained teacher model 107 using an unlabeled dataset retrieved from database 112b to generate compliance pseudo-labels for the unlabeled text. An exemplary sentence from the unlabeled dataset can comprise “In this example, Al will pay $900 less in federal income taxes over the course of the year” and the corresponding pseudo-label generated by teacher model 107 and assigned to the statement by labeling module 109 is “Compliant.”

Next, noise injection module 110 augments (step 306) the pseudo-labeled data by adding neighbors to the sentence to generate noisy data. For example, the noisy data can comprise two sentences that surround the original sentence, such as: “By contributing on a before-tax basis rather than on an after-tax basis, Al can increase his take home pay while saving for his retirement. In this example, Al will pay $900 less in federal income taxes over the course of the year. Based on standard deductions and one exemption and without the deduction of FICA taxes.” As a result, the noisy dataset comprises the original labeled data and the data with newly-created pseudo labels (step 308). Model training module 106b then trains (step 310) a new model that uses an ALBERT architecture on the noisy dataset to create student model 109 (step 312). Student model 109 is now a new teacher model 107 and steps 304, 306, 308, 310 and 312 are repeated a plurality of times (e.g., 3-5 times), each cycle generating a new student model. Then, model training module 106b validates (step 314) the final student model 109 using a validation dataset (i.e., labeled data that was not used during the training process) from database 112a. The final student model 109 is then used on unlabeled text to generate a prediction of compliance for the text.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computer system for predicting compliance of text documents with a ruleset using self-supervised machine learning, the system comprising a server computing device having a memory for storing computer-executable instructions and a processor that executes the computer-executable instructions to:
execute a natural language processing (NLP) teacher model, using as input a first plurality of unlabeled sentences from each of a first plurality of text documents, to generate a first compliance pseudo-label for each unlabeled sentence in the first plurality of unlabeled sentences;
train an NLP student model using the first plurality of unlabeled sentences and associated first compliance pseudo-labels, including injecting input noise during the training process by aggregating each unlabeled sentence with one or more sentences adjacent to each unlabeled sentence into a sentence block and providing the aggregated sentence blocks as input to train the NLP student model;
execute the trained NLP student model, using as input a second plurality of unlabeled sentences from each of a second plurality of text documents, to generate a second compliance pseudo-label for each unlabeled sentence in the second plurality of unlabeled sentences; and
determine whether each text document in the second plurality of text documents is in compliance with one or more rulesets using the second compliance pseudo-labels generated for the text document.

2. The computer system of claim 1, wherein the NLP teacher model and the NLP student model each comprises a deep learning NLP model architecture.

3. The computer system of claim 1, wherein the NLP teacher model is trained using a corpus of text documents where each sentence is associated with a compliance label.

4. The computer system of claim 3, wherein the compliance label is an indicator of whether the corresponding sentence is in compliance with one or more rulesets.

5. The computer system of claim 1, wherein the first compliance pseudo-label is a prediction of whether the corresponding sentence is in compliance with one or more rulesets.

6. The computer system of claim 1, wherein the second compliance pseudo-label is a prediction of whether the corresponding sentence is in compliance with one or more rulesets.

7. The computer system of claim 1, wherein determining whether each text document in the second plurality of text documents is in compliance with one or more rulesets comprises:
determining that the text document in the second plurality of text documents is not in compliance with the one or more rulesets when at least one sentence in the text document is labeled as being non-compliant.

8. The computer system of claim 1, wherein the server computing device:
trains a second NLP student model using the second plurality of unlabeled sentences and associated second compliance pseudo-labels, including injecting input noise during the training process by aggregating each unlabeled sentence with one or more sentences adjacent to each unlabeled sentence into a sentence block and providing the aggregated sentence blocks as input to train the second NLP student model;
executes the trained second NLP student model, using as input a third plurality of unlabeled sentences from each of a third plurality of text documents, to generate a third compliance pseudo-label for each unlabeled sentence in the third plurality of unlabeled sentences; and
determines whether each text document in the third plurality of text documents is in compliance with one or more rulesets using the third compliance pseudo-labels generated for the text document.

9. The computer system of claim 1, wherein the second plurality of text documents comprises a larger number of sentences than the first plurality of text documents.

10. A computerized method of predicting compliance of text documents with a ruleset using self-supervised machine learning, the method comprising:
executing, by the server computing device, a natural language processing (NLP) teacher model, using as input a first plurality of unlabeled sentences from each of a first plurality of text documents, to generate a first compliance pseudo-label for each unlabeled sentence in the first plurality of unlabeled sentences;
training, by the server computing device, an NLP student model using the first plurality of unlabeled sentences and associated first compliance pseudo-labels, including injecting input noise during the training process by aggregating each unlabeled sentence with one or more sentences adjacent to each unlabeled sentence into a sentence block and providing the aggregated sentence blocks as input to train the NLP student model;
executing, by the server computing device, the trained NLP student model, using as input a second plurality of unlabeled sentences from each of a second plurality of text documents, to generate a second compliance pseudo-label for each unlabeled sentence in the second plurality of unlabeled sentences; and
determining, by the server computing device, whether each text document in the second plurality of text documents is in compliance with one or more rulesets using the second compliance pseudo-labels generated for the text document.

11. The method of claim 10, wherein the NLP teacher model and the NLP student model each comprises a deep learning NLP model architecture.

12. The method of claim 10, wherein the NLP teacher model is trained using a corpus of text documents where each sentence is associated with a compliance label.

13. The method of claim 12, wherein the compliance label is an indicator of whether the corresponding sentence is in compliance with one or more rulesets.

14. The method of claim 10, wherein the first compliance pseudo-label is a prediction of whether the corresponding sentence is in compliance with one or more rulesets.

15. The method of claim 10, wherein the second compliance pseudo-label is a prediction of whether the corresponding sentence is in compliance with one or more rulesets.

16. The method of claim 10, wherein determining whether each text document in the second plurality of text documents is in compliance with one or more rulesets comprises:
determining that the text document in the second plurality of text documents is not in compliance with the one or more rulesets when at least one sentence in the text document is labeled as being non-compliant.

17. The method of claim 10, further comprising:
training, by the server computing device, a second NLP student model using the second plurality of unlabeled sentences and associated second compliance pseudo-labels, including injecting input noise during the training process by aggregating each unlabeled sentence with one or more sentences adjacent to each unlabeled sentence into a sentence block and providing the aggregated sentence blocks as input to train the second NLP student model;
executing, by the server computing device, the trained second NLP student model, using as input a third plurality of unlabeled sentences from each of a third plurality of text documents, to generate a third compliance pseudo-label for each unlabeled sentence in the third plurality of unlabeled sentences; and
determining, by the server computing device, whether each text document in the third plurality of text documents is in compliance with one or more rulesets using the third compliance pseudo-labels generated for the text document.

18. The method of claim 10, wherein the second plurality of text documents comprises a larger number of sentences than the first plurality of text documents.
